(19) United States
(12) Patent Application Publication
(10) Pub. No.: US 2025/0076339 A1
(43) Pub. Date: Mar. 6, 2025

(54) SCANNING METHOD AND DEVICE FOR SCANNING PROBE MICROSCOPE BASED ON HIGH-SPEED INSTANTANEOUS FORCE CONTROL

(71) Applicant: SHENYANG INSTITUTE OF AUTOMATION , CHINESE ACADEMY OF SCIENCES, Shenyang, Liaoning (CN)

(72) Inventors: Lianqing LIU, Shenyang, Liaoning (CN); Jialin SHI, Shenyang, Liaoning (CN); Peng YU, Shenyang, Liaoning (CN); Kaixuan WANG, Shenyang, Liaoning (CN); Tie YANG, Shenyang, Liaoning (CN); Yang YANG, Shenyang, Liaoning (CN)

(21) Appl. No.: 18/294,318

(22) PCT Filed: Mar. 9, 2023
(86) PCT No.: PCT/CN2023/080375

§ 371 Date: Feb. 1, 2024

(30) Foreign Application Priority Data
Jul. 25, 2022 (CN) 202210876289.8

(51) Int. Cl. G01Q 60/34; G01Q 10/04

(52) U.S. Cl. CPC G01Q 60/34; G01Q 10/045

(57) ABSTRACT

A scanning probe microscope based on high-speed instantaneous force control is used scan a sample, which includes steps of acquiring an acting force signal between a probe unit and a sample; calculating a real amplitude signal according to the acting force signal; acquiring a set amplitude signal; acquiring the first sinusoidal signal; obtaining a target acting force signal according to the real amplitude signal, the set amplitude signal and the first sinusoidal signal; and scanning the surface of the sample in a target sample scanning mode according to the target acting force signal, wherein the target sample scanning mode represents the operating mode of scanning the surface of the sample under the indication of the target acting force signal. The method solves the problems of low peak force tapping frequency and limited scanning range, and realizes high-speed instantaneous force tapping and mechanical property measurement while ensuring the scanning range.

### TECHNICAL FIELD

The present invention relates to the scanning field of a scanning probe microscope, in particular to a scanning method and device for a scanning probe microscope based on high-speed instantaneous force control.

### BACKGROUND

In the traditional peak force tapping mode, currently, Dimension Fast Scan of Bruker company on the market can achieve the highest scanning speed, which can conduct scanning imaging at a peak force tapping frequency of 8 KHz. However, the maximum scanning range is only 35 um*35 um.

Moreover, Dimension Fast Scan achieves high scanning speed by greatly modifying the scanning head of the previous generation. Meanwhile, the peak force tapping frequency of 8 KHz is only four times higher than the initial 2 KHz, and the speed increase is very limited.

The Fantner group of Swiss Federal Institute of Technology in Lausanne replaces the traditional driving mode of peak force tapping with photothermal effect driving, to achieve a peak force tapping frequency of 100 KHz. However, the defect is that the scanning range is very small, only 1.8 um*1.8 um.

Therefore, the technical point to be solved by those skilled in the art is to increase the modulation frequency of a probe without reducing the scanning range.

### SUMMARY

The present invention provides a scanning method and device for a scanning probe microscope based on high-speed instantaneous force control, so as to solve the problems of low peak force tapping frequency and limited scanning range.

According to the first aspect of the present invention, a scanning method for a scanning probe microscope based on high-speed instantaneous force control is provided, comprising the following steps:
acquiring an acting force signal between a probe unit and a sample, wherein the acting force signal represents the feature that the acting force on the sample changes with time; calculating a real amplitude signal according to the acting force signal, wherein the real amplitude signal represents the amplitude of the acting force signal;
acquiring a set amplitude signal;
acquiring a first sinusoidal signal, and obtaining a target acting force signal according to the real amplitude signal, the set amplitude signal and the first sinusoidal signal;
scanning the surface of the sample in a target sample scanning mode according to the target acting force signal, wherein the target sample scanning mode represents the operating mode of scanning the surface of the sample under the indication of the target acting force signal.

Optionally, the specific steps of calculating the real amplitude signal according to the acting force signal comprise:
acquiring a second sinusoidal signal, and generating a background signal according to the second sinusoidal signal under the trigger of the acting force signal;
obtaining a first acting force signal according to the background signal and the acting force signal, wherein the first acting force signal represents a first real acting force signal after the background signal is subtracted;
obtaining an average baseline signal according to the first acting force signal, wherein the average baseline signal represents the average baseline of the first acting force signal;
obtaining a second acting force signal according to the average baseline signal and the first acting force signal, wherein the second acting force signal represents a second real acting force signal after the average baseline signal is subtracted from the first acting force signal;
obtaining a third acting force signal according to the second acting force signal, wherein the third acting force signal represents a third real acting force signal after the second acting force signal is positive;
obtaining the real amplitude signal according to the third acting force signal.

Optionally, the specific steps of calculating the real amplitude signal according to the acting force signal comprise:
acquiring a third sinusoidal signal;
obtaining a fourth acting force signal according to the third sinusoidal signal and the acting force signal, wherein the fourth acting force signal represents a signal obtained by mixing and multiplying the acting force signal and the third sinusoidal signal;
obtaining the real amplitude signal according to the fourth acting force signal, wherein the real amplitude signal represents the amplitude signal of the acting force signal.

Optionally, the specific steps of acquiring the first sinusoidal signal, and obtaining the target acting force signal according to the real amplitude signal, the set amplitude signal and the first sinusoidal signal comprise:
obtaining an error signal according to the real amplitude signal and the set amplitude signal, wherein the error signal represents the error information of the real amplitude signal and the set amplitude signal;
obtaining a control signal according to the error signal;
acquiring the first sinusoidal signal;
obtaining the target acting force signal according to the first sinusoidal signal and the control signal.

Optionally, the specific steps of acquiring the acting force signal between the probe unit and the sample comprise:
acquiring the target acting force signal;
conducting scanning in the target sample scanning mode according to the target acting force signal;
detecting a scanning process during the scanning in the target sample scanning mode, to generate the acting force signal.

According to the second aspect of the present invention, a method for measuring mechanical properties based on a scanning probe microscope is provided, used for measuring the mechanical properties of the surface of the sample. The method comprises the following steps:
scanning the surface of the sample according to the scanning method for the scanning probe microscope based on high-speed instantaneous force control in any item of the first aspect of the present invention to form scanning motion, and obtaining the acting force signal, wherein the acting force signal represents the feature that the acting force signal changes with time;
obtaining quantitative values according to the acting force signal, wherein the quantitative values represent the surface features of the sample.

Optionally, the specific steps of obtaining the quantitative values according to a sample scanning signal comprise:
obtaining a fifth acting force signal according to the sample scanning signal, wherein the fifth acting force signal represents the feature that the acting force on the sample changes with a distance between the sample and a force applying side;
determining several quantitative values according to a contact mechanical model and the fifth acting force signal.

Optionally, the quantitative values comprise: Van der Waals force or/and capillary adhesion between the sample and the force applying side.

According to the third aspect of the present invention, a scanning device for a scanning probe microscope based on high-speed instantaneous force control is provided, comprising: a scanning module, a real amplitude calculating module, a set amplitude generating module and a target acting force signal generating module.

One end of the scanning module is connected with one end of the real amplitude calculating module, and the other end of the scanning module is connected with one end of the target acting force signal generating module; and the other end of the target acting force signal generating module is connected with the other end of the real amplitude calculating module and the set amplitude generating module.

The scanning module is used for scanning the surface of the sample to generate the acting force signal and transmitting the acting force signal to the real amplitude calculating module.

The real amplitude calculating module is used for obtaining the real amplitude signal according to the acting force signal and transmitting the real amplitude signal to the target acting force signal generating module.

The set amplitude generating module is used for generating the set amplitude signal and transmitting the set amplitude signal to the target acting force signal generating module.

The target acting force signal generating module is used for generating the target acting force signal by the real amplitude signal and the set amplitude signal and transmitting the target acting force signal to the scanning module, so as to control the scanning module to conduct scanning operation in the target sample scanning mode according to the target acting force signal.

Optionally, the scanning module specifically comprises:
a beam transmitting unit, a signal detecting unit, a longitudinal piezoelectric driving unit, a probe holding unit, a probe cantilever beam unit and a probe unit;
wherein one end of the probe unit is installed in the probe holding unit, the probe cantilever beam unit is connected with the probe holding unit, the probe cantilever beam unit supports the probe unit, and the other end of the probe unit extends from the probe cantilever beam unit; one end of the longitudinal piezoelectric driving unit is connected with the probe holding unit, and the other end of the longitudinal piezoelectric driving unit is connected with the target acting force signal generating module; and the signal detecting unit is connected with one end of the real amplitude calculating module.

The probe unit is used for periodically acting on the surface of the sample with a certain acting force; and the probe unit is controlled by the longitudinal piezoelectric driving unit.

The longitudinal piezoelectric driving unit is used for driving the probe unit to operate in the target sample scanning mode by using a received target sample scanning signal.

The beam transmitting unit is used for transmitting a light beam to the probe cantilever beam unit.

The probe cantilever beam unit is used for supporting the probe unit together with the probe holding unit and reflecting the received light beam transmitted by the beam transmitting unit into the signal detecting unit.

The signal detecting unit is used for generating the sample scanning signal according to the detected reflected light beam on the probe cantilever beam unit and transmitting the sample scanning signal to a mechanical property calculating module and the real amplitude calculating module.

Optionally, the real amplitude calculating module specifically comprises:
a background generating unit, a first comparison unit, a baseline average analysis unit, a second comparison unit, a signal positivity unit, a second integral operation unit and a sinusoidal signal generating unit.

One end of the background generating unit is connected with the signal detecting unit, and the other end of the background generating unit is connected with one end of the first comparison unit and one end of the sinusoidal signal generating unit; one end of the first comparison unit is also connected with the signal detecting unit, and the other end of the first comparison unit is connected with one end of the baseline average analysis unit and one end of the second comparison unit; the other end of the baseline average analysis unit is connected with one end of the second comparison unit; the other end of the second comparison unit is connected with one end of the signal positivity unit; the other end of the signal positivity unit is connected with one end of the second integral operation unit; and the other end of the second integral operation unit is connected with the target acting force signal generating module.

The sinusoidal signal generating unit is used for generating the first sinusoidal signal, the second sinusoidal signal or the third sinusoidal signal, transmitting the second sinusoidal signal or the third sinusoidal signal to the real amplitude calculating module, and transmitting the first sinusoidal signal to the target acting force signal generating module.

The background generating unit is used for triggering the background generating unit to generate a background signal according to the received second sinusoidal signal when the acting force signal is received, and transmitting the background signal to the first comparison unit.

The first comparison unit is used for obtaining the first acting force signal according to the received background signal and the acting force signal, and transmitting the first acting force signal to the baseline average analysis unit and the second comparison unit.

The baseline average analysis unit is used for generating an average baseline signal according to the received first acting force signal and transmitting the average baseline signal to the second comparison unit.

The second comparison unit is used for obtaining the second acting force signal according to the received average baseline signal and the first acting force signal, and transmitting the second acting force signal to the signal positivity unit.

The signal positivity unit is used for obtaining the third acting force signal according to the second acting force signal, and transmitting the third acting force signal to the second integral operation unit.

The second integral operation unit is used for obtaining the real amplitude signal according to the third acting force signal and transmitting the real amplitude signal to the target acting force signal generating module.

Optionally, the real amplitude calculating module specifically comprises:
a phase sensitive detection unit and a low-pass filter unit.

One end of the phase sensitive detection unit is connected with the signal detecting unit, the other end of the phase sensitive detection unit is connected with one end of the low-pass filter unit, and the other end of the low-pass filter unit is connected with the target acting force signal generating module.

The phase sensitive detection unit is used for obtaining the fourth acting force signal according to the received acting force signal and the third sinusoidal signal, and transmitting the fourth acting force signal to the low-pass filtering unit.

The low-pass filter unit is used for obtaining the real amplitude signal according to the fourth acting force signal and transmitting the real amplitude signal to the target acting force signal generating module.

Optionally, the target acting force signal generating module specifically comprises:
a third comparison unit, a control signal generating unit and a summing unit.

One end of the third comparison unit is connected with the other end of the real amplitude calculating module and the set amplitude calculating module;
the other end of the third comparison unit is connected with one end of the control signal generating unit; the other end of the control signal generating unit is connected with one end of the summing unit; and the other end of the summing unit is connected with the other end of the longitudinal piezoelectric driving unit and the other end of the sinusoidal signal generating unit.

The third comparison unit is used for generating an error signal according to the real amplitude signal and the set amplitude signal, and transmitting the error signal to the control signal generating unit.

The control signal generating unit is used for generating a control signal according to the error signal and transmitting the control signal to the summing unit.

The summing unit is used for generating the target acting force signal according to the first sinusoidal signal and the control signal and transmitting the target acting force signal to the scanning module.

According to the fourth aspect of the present invention, a scanning system for a scanning probe microscope based on high-speed instantaneous force control is provided, comprising: the scanning device for the scanning probe microscope based on high-speed instantaneous force control in any item of the third aspect of the present invention, which is used for scanning the sample under the control of the set amplitude signal and generating the acting force signal; and
a mechanical property calculating module, wherein the mechanical property calculating module is connected with the scanning module for receiving the acting force signal transmitted by the scanning module and calculating quantitative values according to the acting force signal, and the quantitative values represent the surface features of the sample.

The scanning method for the scanning probe microscope based on high-speed instantaneous force control provided by the present invention comprises: obtaining the real amplitude signal according to the acquired acting force signal between the probe unit and the sample; and generating the target acting force signal according to the real amplitude signal and the set amplitude signal so that the probe unit scans the surface of the sample in the sample scanning mode under the control of the target acting force signal. Because the target sample acting force signal used to control the probe unit to operate in the target sample scanning mode is generated according to the set amplitude signal and the real amplitude signal, the scanning mode of the probe unit is controlled by the set amplitude signal. Therefore, the technical solution provided by the present invention realizes scanning imaging under the control of the set amplitude signal. The instantaneous force based on the peak force tapping mode controls the probe unit for scanning, which solves the problem of limited scanning range compared with scanning by other scanning principles, and ensures the requirements for the product scanning range.

Further, the surface of the sample is scanned according to the scanning method for the scanning probe microscope based on high-speed instantaneous force control to form scanning motion, and the acting force signal between the probe unit and the sample is obtained; and the quantitative values are obtained according to the acting force signal. It can be seen that the quantitative values are obtained directly according to the acting force signal, which solves the problem of low peak force tapping frequency and realizes high-frequency peak force tapping.

In conclusion, the present invention ensures the requirements for the probe scanning range while ensuring the high-frequency peak force tapping.

### DESCRIPTION OF DRAWINGS

To more clearly describe the technical solutions in the embodiments of the present invention or in the prior art, the drawings required to be used in the description of the embodiments or the prior art will be simply presented below. Obviously, the drawings in the following description are merely some embodiments of the present invention, and for those ordinary skilled in the art, other drawings can also be obtained according to the drawings without contributing creative labor.

FIG. 1 is a flow chart of a scanning method for a scanning probe microscope based on high-speed instantaneous force control in an embodiment of the present invention;

FIG. 2 is a flow chart of a method for measuring mechanical properties based on a scanning probe microscope in an embodiment of the present invention;

FIG. 3 is a schematic diagram of a scanning device for a scanning probe microscope based on high-speed instantaneous force control in an embodiment of the present invention;

FIG. 4 is a schematic diagram of a scanning module in an embodiment of the present invention;

FIG. 5 is a schematic diagram of a real amplitude calculating module in an embodiment of the present invention;

FIG. 6 is a schematic diagram of a real amplitude calculating module in another embodiment of the present invention;

FIG. 7 is a schematic diagram of a target acting force signal generating module in an embodiment of the present invention;

FIG. 8 is a schematic diagram of a specific connection relationship of a scanning device of a scanning device for a scanning probe microscope based on high-speed instantaneous force control in an embodiment of the present invention;

FIG. 9 is a schematic diagram of a specific connection relationship of a scanning device of a scanning device for a scanning probe microscope based on high-speed instantaneous force control in another embodiment of the present invention;

FIG. 10 is a schematic diagram of a scanning system for a scanning probe microscope based on high-speed instantaneous force control in an embodiment of the present invention;

FIG. 11 is a schematic diagram of a scanning system for a scanning probe microscope based on high-speed instantaneous force control in a specific embodiment of the present invention;

FIG. 12 is a schematic diagram of a scanning system for a scanning probe microscope based on high-speed instantaneous force control in another specific embodiment of the present invention;

FIG. 13 is a schematic diagram of the interaction between a probe unit and a sample in a time stamp in a specific embodiment of the present invention.

### REFERENCE SIGNS

1—probe cantilever beam;
2—probe tip;
3—laser;
4—laser light emitted by the laser;
5—laser light reflected from a back surface of the cantilever beam;
6—four-quadrant photoelectric detector;
7—laser spot longitudinal deflection signal;
8—probe holder;
9—sample;
10, 11, 12—comparators;
13—summing unit.

### DETAILED DESCRIPTION

The technical solutions in the embodiments of the present invention will be clearly and fully described below in combination with the drawings in the embodiments of the present invention.

Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

The terms such as “first”, “second”, “third”, “fourth” and the like (if exit) in the description, claims and drawings in the present invention are used for distinguishing similar objects rather than used for describing special order or precedence order. It shall be understood that such data may be exchanged under appropriate circumstances so that the embodiments of the present invention described herein may be implemented in the order other than those illustrated or described herein.

Moreover, terms of “comprise” and “have” as well as any other variant are intended to cover non-exclusive inclusion, for example, processes, methods, systems, products or devices including a series of steps or units are not limited to those steps or units clearly listed, but include other steps or units that are not listed clearly or are inherent to these processes, methods, products or devices.

In the traditional peak force tapping mode, currently, Dimension Fast Scan of Bruker company on the market can achieve the highest scanning speed, which can conduct scanning imaging at a peak force tapping frequency of 8 KHz. However, the maximum scanning range is only 35 um*35 um.

Moreover, Dimension Fast Scan achieves high scanning speed by greatly modifying the scanning head of the previous generation. Meanwhile, the peak force tapping frequency of 8 KHz is only four times higher than the initial 2 KHz, and the speed increase is very limited.

The Fantner group of Swiss Federal Institute of Technology in Lausanne replaces the traditional driving mode of peak force tapping with photothermal effect driving, to achieve a peak force tapping frequency of 100 KHz. However, the defect is that the scanning range is very small, only 1.8 um*1.8 um.

In view of this, according to multiple experimental verification, the inventor has found that a method for calculating the quantitative values by only the received acting force signal between the sample and the probe by isolating the mechanical property calculating module solves the problem of low peak force tapping frequency and realizes high-frequency peak force tapping.

An instantaneous force set point is introduced to control probe scanning, and combined with the peak force tapping mode in the prior art, which solves the problem of limited scanning range and ensures the requirements for the scanning range.

The high-speed instantaneous force control and nanometer quantitative mechanical property measurement method of the present invention changes the control method only without any modification of the existing atomic force microscope system structure, to ensure the scanning range while increasing the probe modulation frequency by 100 times.

The technical solution of the present invention is described in detail below through specific embodiments. The following specific embodiments may be combined with each other, and the same or similar concepts or processes may not be repeated in some embodiments.

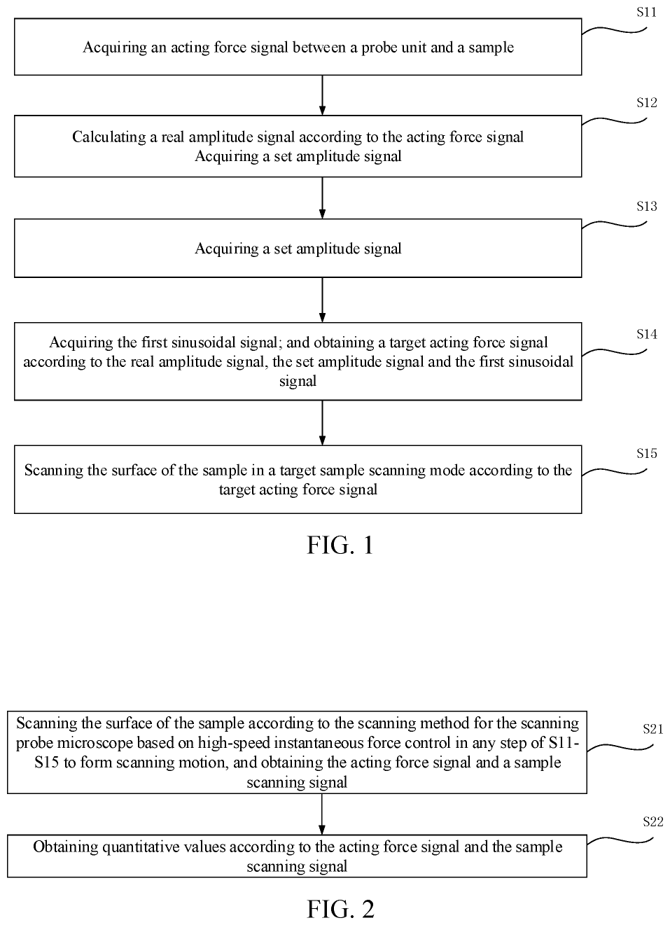

By referring to FIG. 1, according to an embodiment of the present invention, a scanning method for a scanning probe microscope based on high-speed instantaneous force control is provided, wherein the scanning probe microscope comprises a probe unit. The method comprises the following steps:
S11: acquiring an acting force signal between the probe unit and a sample, wherein the acting force signal represents the feature that the acting force on the sample changes with time;
S12: calculating a real amplitude signal according to the acting force signal, wherein the real amplitude signal represents the amplitude of the acting force signal;
S13: acquiring a set amplitude signal;
S14: acquiring a first sinusoidal signal, and obtaining a target acting force signal according to the real amplitude signal, the set amplitude signal and the first sinusoidal signal;
S15: scanning the surface of the sample in a target sample scanning mode according to the target acting force signal, wherein the target sample scanning mode represents the operating mode of scanning the surface of the sample under the indication of the target acting force signal.

Steps S11-S15 are executed circularly.

Wherein the acting force signal between the probe unit and the sample acquired in step S11 is a signal generated by scanning the scanning surface by the scanning module. The technical solution of the present invention introduces an instantaneous force set point signal, and combines the instantaneous force control with the peak force tapping mode scanning to realize the peak force tapping under control of the instantaneous force. Compared with the scanning mode under photothermal effect driving in the prior art, the present invention solves the problem of limited scanning range and ensures the requirements for the scanning range.

In one embodiment, the step S11 of acquiring the acting force signal between the probe unit and the sample specifically comprises:
step S111: acquiring the target acting force signal;
step S112: conducting scanning in the target sample scanning mode according to the target acting force signal;
step S113: detecting a scanning process during the scanning in the target sample scanning mode, to generate the acting force signal.

In one embodiment, the step S12 of calculating the real amplitude signal according to the acting force signal specifically comprises:
step S121: acquiring a second sinusoidal signal, and generating a background signal according to the second sinusoidal signal under the trigger of the acting force signal;
step S122: obtaining an average baseline signal according to the first acting force signal, wherein the average baseline signal represents the average baseline of the first acting force signal;
step S123: obtaining a second acting force signal according to the average baseline signal and the first acting force signal, wherein the second acting force signal represents a second real acting force signal after the average baseline signal is subtracted from the first acting force signal;
step S124: obtaining a third acting force signal according to the second acting force signal, wherein the third acting force signal represents a third real acting force signal after the second acting force signal is positive;
step S125: obtaining the real amplitude signal according to the third acting force signal.

In another embodiment, the step S12 of calculating the real amplitude signal according to the acting force signal specifically comprises:
step S121: acquiring a third sinusoidal signal;
step S122: obtaining a fourth acting force signal according to the third sinusoidal signal and the acting force signal, wherein the fourth acting force signal represents a signal obtained by mixing and multiplying the acting force signal and the third sinusoidal signal;
step S123: obtaining the real amplitude signal according to the fourth acting force signal, wherein the real amplitude signal represents the amplitude signal of the acting force signal.

In one embodiment, the step S14 of acquiring the first sinusoidal signal, and obtaining the target acting force signal according to the real amplitude signal, the set amplitude signal and the first sinusoidal signal specifically comprises:
step S141: obtaining an error signal according to the real amplitude signal and the set amplitude signal, wherein the error signal represents the error information of the real amplitude signal and the set amplitude signal;
step S142: obtaining a control signal according to the error signal;
step S143: acquiring the first sinusoidal signal;
step S144: obtaining the target acting force signal according to the first sinusoidal signal and the control signal.

Secondly, according to an embodiment of the present invention, a method for measuring mechanical properties based on a scanning probe microscope is further provided, used for measuring the mechanical properties of the surface of the sample, with reference to FIG. 2. As shown in FIG. 2, the method for measuring mechanical properties based on the scanning probe microscope provided by the present embodiment comprises the following steps:
S21: scanning the surface of the sample according to the scanning method for the scanning probe microscope based on high-speed instantaneous force control in the above embodiment to form scanning motion, and obtaining the acting force signal, wherein the acting force signal represents the feature that the acting force signal changes with time;
S22: obtaining quantitative values according to the acting force signal, wherein the quantitative values represent the surface features of the sample.

The mechanical property calculation in the technical solution of the present invention does not participate in the circles of the instantaneous force control and the peak force tapping in the above embodiment, and the quantitative values are obtained directly based on the acting force signal for imaging of the sample surface. Compared with the prior art, high-frequency peak force tapping is achieved without changing the equipment, and the problem of low modulation frequency of the probe unit is solved. The technical effect that the modulation frequency of the probe is increased by 100 times is achieved.

In one embodiment, the step S22 of obtaining the quantitative values according to the sample scanning signal specifically comprises:
step S221: obtaining a fifth acting force signal according to the sample scanning signal, wherein the fifth acting force signal represents the feature that the acting force on the sample changes with a distance between the sample and a force applying side;
step S222: determining several quantitative values according to a contact mechanical model and the fifth acting force signal.

In one embodiment, the quantitative values comprise: Van der Waals force or/and capillary adhesion between the sample and the force applying side.

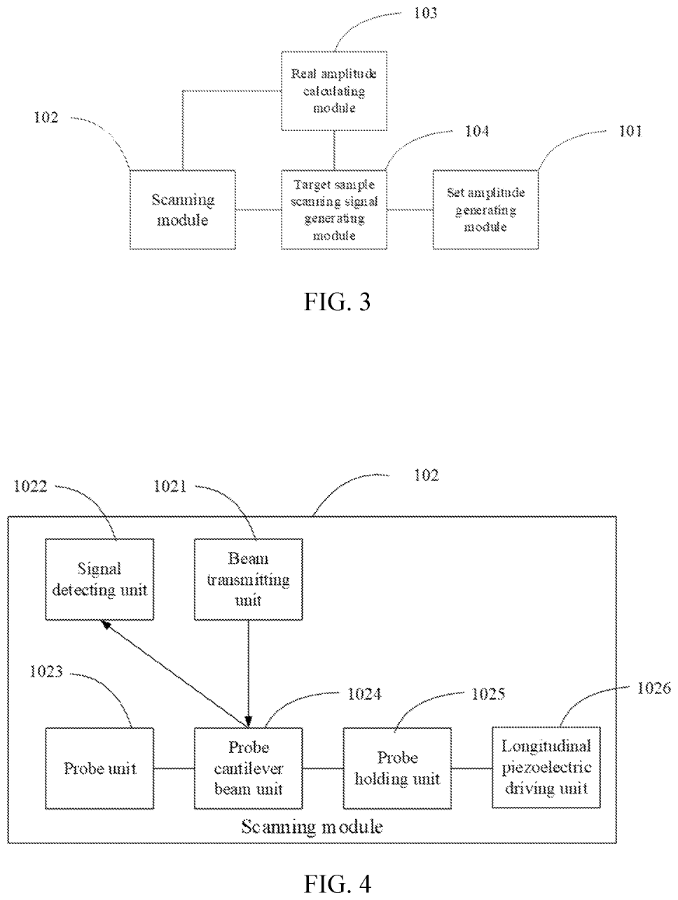

By referring to FIG. 3 to FIG. 9, according to an embodiment of the present invention, a scanning device for a scanning probe microscope based on high-speed instantaneous force control is further provided. As shown in FIG. 3, the device comprises:
a scanning module 102, a real amplitude calculating module 103, a set point amplitude generating module 101 and a target acting force signal generating module 104.

One end of the scanning module 102 is connected with one end of the real amplitude calculating module 103, and the other end of the scanning module 102 is connected with one end of the target acting force signal generating module 104; and the other end of the target acting force signal generating module 104 is connected with the other end of the real amplitude calculating module 103 and the instantaneous force set amplitude generating module 101.

The scanning module 102 is used for scanning the surface of the sample to generate the acting force signal and transmitting the acting force signal to the real amplitude calculating module 103.

The scanning module 102 uses the peak force tapping mode for scanning.

The real amplitude calculating module 103 is used for obtaining the real amplitude signal according to the acting force signal and transmitting the real amplitude signal to the target acting force signal generating module 104.

The set amplitude generating module 101 is used for generating the set amplitude signal and transmitting the set amplitude signal to the target acting force signal generating module 104.

The target acting force signal generating module 104 is used for generating the target acting force signal by the real amplitude signal and the set amplitude signal and transmitting the target acting force signal to the scanning module 102, so as to control the scanning module 102 to conduct scanning operation in the target sample scanning mode according to the target acting force signal.

The scanning device for the scanning probe microscope based on high-speed instantaneous force control in the present invention uses the set amplitude generating module 101 for realizing the instantaneous force control, and combines the real amplitude calculating module 103, the scanning module 102, the set amplitude generating module 101 and the target acting force generating module to realize peak force tapping scanning imaging under the control of the instantaneous force. The problem of limited scanning range in the prior art is solved and the requirements for the scanning range are realized.

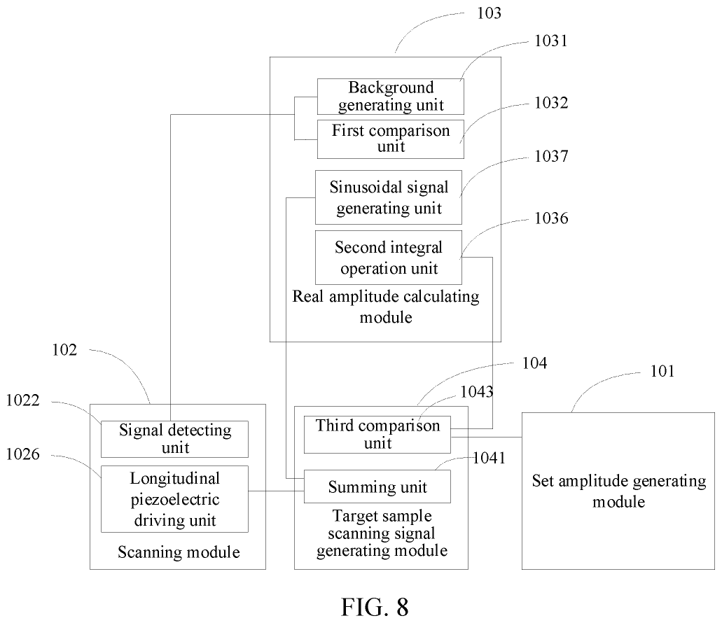

As shown in FIG. 3, FIG. 4 and FIG. 8, in one embodiment, the scanning module 102 specifically comprises:
a beam transmitting unit 1021, a signal detecting unit 1022, a longitudinal piezoelectric driving unit 1026, a probe holding unit 1025, a probe cantilever beam unit 1024 and a probe unit 1023;
wherein one end of the probe unit 1023 is installed in the probe holding unit 1025, the probe cantilever beam unit 1024 is connected with the probe holding unit 1025, the probe cantilever beam unit 1024 supports the probe unit 1023, and the other end of the probe unit 1023 extends from the probe cantilever beam unit 1024; one end of the longitudinal piezoelectric driving unit 1026 is connected with the probe holding unit 1025, and the other end of the longitudinal piezoelectric driving unit 1026 is connected with the target acting force signal generating module 104; and the signal detecting unit 1022 is connected with one end of the real amplitude calculating module 103.

Specifically, the probe holding unit 1025 is a probe holder 8, and of course, may also be another probe holding unit 1025, which is not limited by the present invention. The realization form of any probe holding unit is within the protection scope of the present invention.

The probe unit 1023 is used for periodically acting on the surface of the sample with a certain acting force; and the probe unit 1023 is controlled by the longitudinal piezoelectric driving unit 1026. In a specific embodiment, the probe unit 1023 is a probe.

The longitudinal piezoelectric driving unit 1026 is used for driving the probe unit 1023 to operate in the target sample scanning mode by using a received target sample scanning signal.

Specifically, the longitudinal piezoelectric driving unit 1026 is a longitudinal piezoelectric driver, and may also be another longitudinal piezoelectric driving unit 1026, which is not limited by the present invention. The realization form of any longitudinal piezoelectric driving unit is within the protection scope of the present invention.

The beam transmitting unit 1021 is used for transmitting a light beam to the probe cantilever beam unit 1024. Specifically, the beam transmitting unit 1021 is a laser 3, and may also be another beam transmitting unit 1021, which is not limited by the present invention. The realization form of any beam transmitting unit is within the protection scope of the present invention.

The probe cantilever beam unit 1024 is used for supporting the probe unit 1023 together with the probe holding unit 1025 and reflecting the received light beam transmitted by the beam transmitting unit 1021 into the signal detecting unit 1022. Specifically, the probe cantilever beam unit 1024 is a probe cantilever beam 1, and may also be another probe cantilever beam unit 1024, which is not limited by the present invention. The realization form of any probe cantilever beam unit is within the protection scope of the present invention.

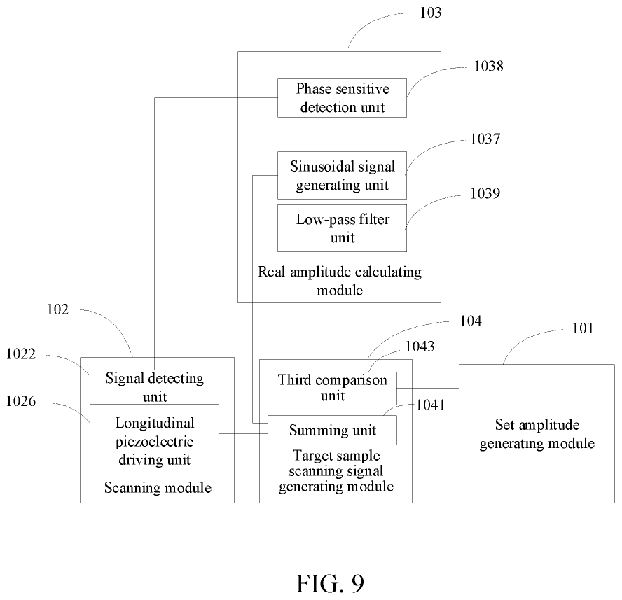

The signal detecting unit 1022 is used for generating the sample scanning signal according to the detected reflected light beam on the probe cantilever beam unit and transmitting the sample scanning signal to the real amplitude calculating module 103. Specifically, the signal detecting unit 1022 is a four-quadrant photoelectric detector 6, and may also be another signal detecting unit 1022, which is not limited by the present invention. The realization form of any signal detecting unit is within the protection scope of the present invention, as shown in FIG. 4, FIG. 8 and FIG. 9.

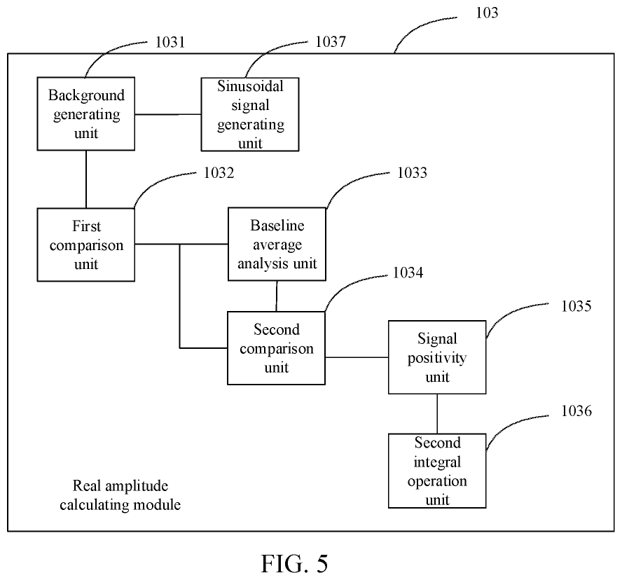

As shown in FIG. 3, FIG. 5 and FIG. 8, in one embodiment, the real amplitude calculating module 103 specifically comprises:
a background generating unit 1031, a first comparison unit 1032, a baseline average analysis unit 1033, a second comparison unit 1034, a signal positivity unit 1035, a second integral operation unit 1036 and a sinusoidal signal generating unit 1037.

One end of the background generating unit 1031 is connected with the signal detecting unit 1022, and the other end of the background generating unit 1031 is connected with one end of the first comparison unit 1032 and one end of the sinusoidal signal generating unit 1037; one end of the first comparison unit 1032 is also connected with the signal detecting unit 1022, and the other end of the first comparison unit 1032 is connected with one end of the baseline average analysis unit 1033 and one end of the second comparison unit 1034; the other end of the baseline average analysis unit 1033 is connected with one end of the second comparison unit 1034; the other end of the second comparison unit 1034 is connected with one end of the signal positivity unit 1035; the other end of the signal positivity unit 1035 is connected with one end of the second integral operation unit 1036; and the other end of the second integral operation unit 1036 is connected with the target acting force signal generating module 104.

The sinusoidal signal generating unit 1037 is used for generating the first sinusoidal signal, the second sinusoidal signal or the third sinusoidal signal, transmitting the second sinusoidal signal or the third sinusoidal signal to the real amplitude calculating module 103, and transmitting the first sinusoidal signal to the target acting force signal generating module 104. Specifically, the sinusoidal signal generating unit 1037 is a sinusoidal signal generator, and may also be another sinusoidal signal generating unit 1037, which is not limited by the present invention. The realization form of any sinusoidal signal generating unit is within the protection scope of the present invention.

The background generating unit 1031 is used for triggering the background generating unit 1031 to generate a background signal according to the received second sinusoidal signal when the acting force signal is received, and transmitting the background signal to the first comparison unit 1032.

Specifically, the background generating unit 1031 is a background generator, and may also be another type of background generating unit 1031, which is not limited by the present invention. The realization form of any background generating unit is within the protection scope of the present invention.

The first comparison unit 1032 is used for obtaining the first acting force signal according to the received background signal and the acting force signal, and transmitting the first acting force signal to the baseline average analysis unit 1033 and the second comparison unit 1034. Specifically, the first comparison unit 1032 is a comparator 10, and may also be another type of first comparison unit 1032, which is not limited by the present invention. The realization form of any first comparison unit is within the protection scope of the present invention.

The baseline average analysis unit 1033 is used for generating an average baseline signal according to the received first acting force signal and transmitting the average baseline signal to the second comparison unit 1034.

The second comparison unit 1034 is used for obtaining the second acting force signal according to the received average baseline signal and the first acting force signal, and transmitting the second acting force signal to the signal positivity unit 1035. The second comparison unit 1034 is a comparator 11, and may also be another type of second comparison unit 1034, which is not limited by the present invention. The realization form of any second comparison unit is within the protection scope of the present invention.

The signal positivity unit 1035 is used for obtaining the third acting force signal according to the second acting force signal, and transmitting the third acting force signal to the second integral operation unit 1036.

The second integral operation unit 1036 is used for obtaining the real amplitude signal according to the third acting force signal and transmitting the real amplitude signal to the target acting force signal generating module 104, as shown in FIG. 5 and FIG. 8.

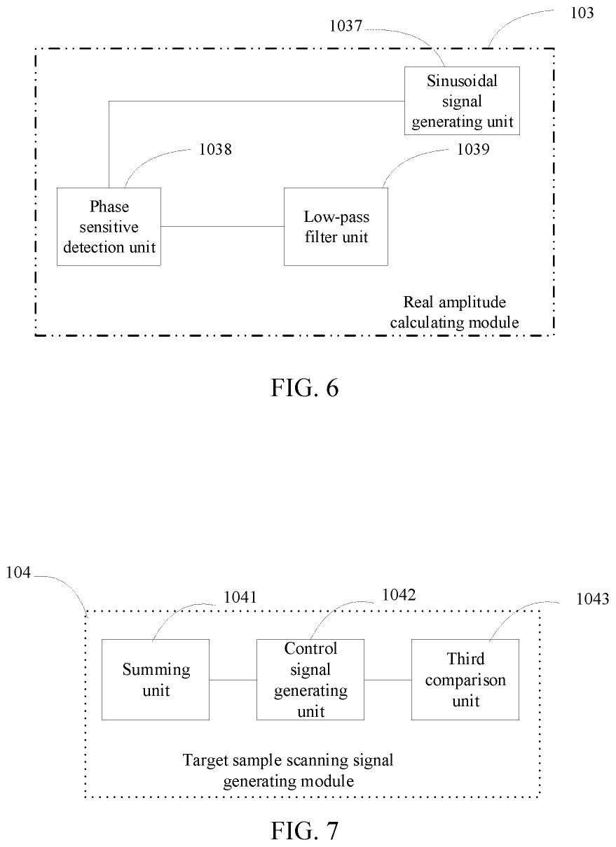

For another embodiment of the real amplitude calculating module, as shown in FIG. 3, FIG. 6 and FIG. 9, the real amplitude calculating module 103 specifically comprises:
a phase sensitive detection unit 1038 and a low-pass filter unit 1039.

One end of the phase sensitive detection unit 1038 is connected with the signal detecting unit 1022, the other end of the phase sensitive detection unit 1038 is connected with one end of the low-pass filter unit 1039, and the other end of the low-pass filter unit 1039 is connected with the target acting force signal generating module 104.

The phase sensitive detection unit 1038 is used for obtaining the fourth acting force signal according to the received acting force signal and the third sinusoidal signal, and transmitting the fourth acting force signal to the low-pass filtering unit 1039.

The low-pass filter unit 1039 is used for obtaining the real amplitude signal according to the fourth acting force signal and transmitting the real amplitude signal to the target acting force signal generating module 104, as shown in FIG. 6 and FIG. 9.

As shown in FIG. 3, FIG. 7 and FIG. 8, in one embodiment, the target acting force signal generating module 104 specifically comprises:
a third comparison unit 1043, a control signal generating unit 1042 and a summing unit 1041.

One end of the third comparison unit 1043 is connected with the other end of the real amplitude calculating module 103 and the set amplitude calculating module; the other end of the third comparison unit 1043 is connected with one end of the control signal generating unit 1042; the other end of the control signal generating unit 1042 is connected with one end of the summing unit 1041; and the other end of the summing unit 1041 is connected with the other end of the longitudinal piezoelectric driving unit and the other end of the sinusoidal signal generating unit.

The third comparison unit 1043 is used for generating an error signal according to the real amplitude signal and the set amplitude signal, and transmitting the error signal to the control signal generating unit 1042. The third comparison unit 1043 is a comparator 12, and may also be another type of third comparison unit 1043, which is not limited by the present invention. The realization form of any third comparison unit is within the protection scope of the present invention.

The control signal generating unit 1042 is used for generating a control signal according to the error signal and transmitting the control signal to the summing unit 1041. Specifically, the control signal generating unit 1042 is a PI controller, and may also be another type of control signal generating unit 1042, which is not limited by the present invention. The realization form of any control signal generating unit is within the protection scope of the present invention.

The summing unit 1041 is used for generating the target acting force signal according to the first sinusoidal signal and the control signal and transmitting the target acting force signal to the scanning module 102, as shown in FIG. 8 and FIG. 9.

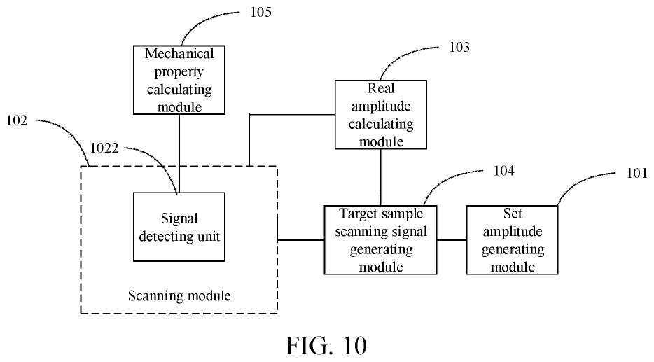

By referring to FIG. 10, according to an embodiment of the present invention, a scanning system for a scanning probe microscope based on high-speed instantaneous force control is further provided.

The system comprises: the scanning device for the scanning probe microscope based on high-speed instantaneous force control in the above embodiment and a mechanical property calculating module 105, wherein:

The scanning device for the scanning probe microscope based on high-speed instantaneous force control is used for scanning the sample under the control of an instantaneous force point and generating the acting force signal; the mechanical property calculating module 105 is connected with the scanning module 102 for receiving the acting force signal transmitted by the scanning module 102 and calculating quantitative values according to the acting force signal; and the quantitative values represent the surface features of the sample.

In the technical solution of the present invention, based on peak force tapping scanning imaging under the control of the instantaneous force, the mechanical property calculating module 105 is independent of the cycle formed by the set amplitude generating module, the real amplitude calculating module 103 and the target acting force signal generating module 104, and the quantitative values are generated directly based on the acting force signal generated by the scanning module 102 for imaging. Compared with the prior art, on the basis of solving the problem of limited scanning range in the prior art, the problem of low scanning frequency is solved. Meanwhile, the requirements for the scanning range and the scanning frequency are improved.

In one embodiment, the mechanical property calculating module 105 is specifically connected with the signal detecting unit 1022 in the scanning module 102 for receiving the acting force signal transmitted by the signal detecting unit 1022 and calculating quantitative values according to the acting force signal; and the quantitative values represent the surface features of the sample, as shown in FIG. 10.

In a specific embodiment, the scanning probe microscope is an atomic force microscope, but is not limited to the atomic force microscope, and may also be a transverse force microscope, a scanning tunneling microscope or an electrostatic force microscope. It should be certainly understood that the scanning probe microscope of the present invention is not limited to this and is within the protection scope of the present invention as long as it meets the requirements of the present invention.

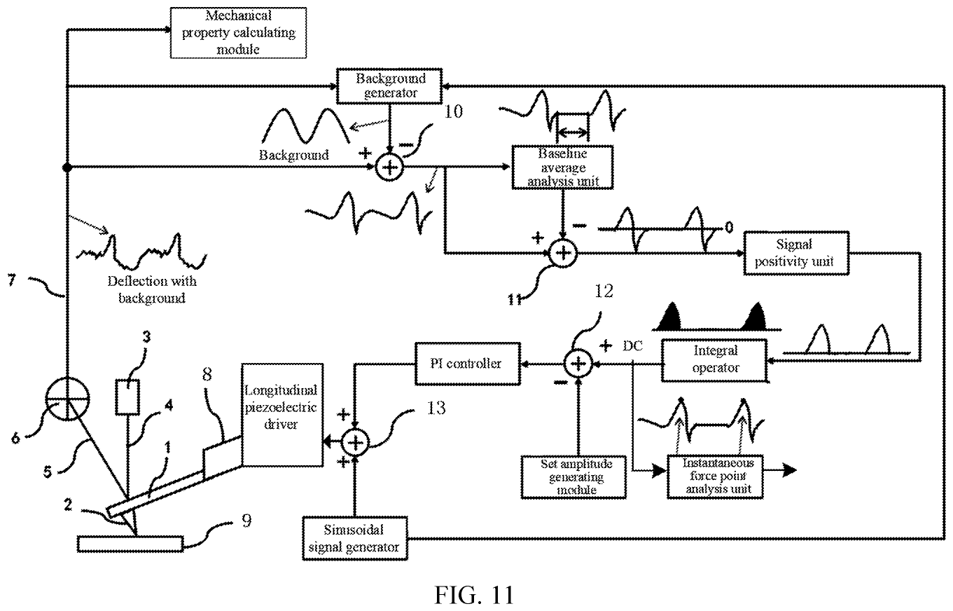

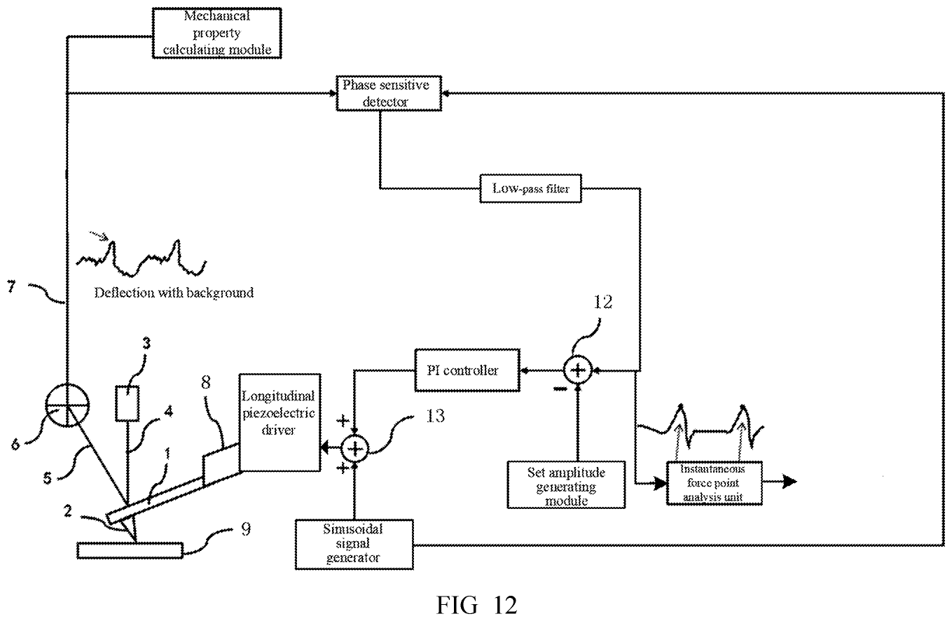

The present invention is further described below in detail by taking the atomic force microscope as an example in combination with a specific embodiment of the present invention, as shown in FIG. 11-FIG. 13.

As shown in FIG. 11, a probe is installed in a probe holder 8 and has a probe cantilever beam 1 that supports a probe tip 2. In this case, the probe tip-sample separation is modulated by the longitudinal piezoelectric driver. The laser 3 emits laser light onto the probe cantilever beam 1, and the laser light reflected from the probe cantilever beam 1 is captured by the four-quadrant photoelectric detector 6.

In the operation process, the four-quadrant photoelectric detector 6 generates a laser spot longitudinal deflection signal 7 according to the reflected light of the laser light 4 emitted by the laser 3, that is, the laser light 5 reflected from the back surface of the cantilever beam, and the laser spot longitudinal deflection signal 7 is the acting force signal.

The laser spot longitudinal deflection signal 7 is then transmitted to the background generator, and the background generator generates a background signal which refers to a periodic waveform of the background signal when the probe tip does not interact with the sample.

The comparator 10 processes the acting force signal by subtracting the background signal 7 to produce the first acting force signal, and the first acting force signal represents a signal of the probe tip-sample interaction independent of the parasitic background.

The first acting force signal is transmitted to the baseline average analysis unit to determine a baseline and generate an average baseline signal.

The comparator 11 processes the first acting force signal by subtracting the average baseline signal to produce the second acting force signal, and the second acting force signal represents a signal of the tip-sample interaction without cantilever DC drift.

The signal is further transmitted to the signal positivity unit, so as to obtain the third acting force signal. The third acting force signal represents that the laser spot longitudinal deflection signal 7 only leaves a positive deflection signal, and transmits the deflection signal to an integral operator.

The real amplitude signal is obtained through integral operation. The real amplitude signal refers to the amplitude of the deflection signal after taking a positive, and is transmitted to a comparator 12 in the form of DC.

The set amplitude generating module 101 generates a set amplitude signal and transmits the amplitude signal to the comparator 12. The comparator 12 compares the set amplitude signal with the real amplitude signal to generate an error signal, and transmits the error signal to a PI controller to generate a control signal. The control signal is then transmitted to the summing unit 13, and is combined with the first sinusoidal signal generated by the sinusoidal signal generator to generate a target acting force signal. The summing unit 13 then applies the target acting force signal to the longitudinal piezoelectric driver to drive the probe holder 8 so that the probe maintains the interaction between the probe tip 2 and the sample 9 in a basically stable state.

While the control loop is operated, the laser spot longitudinal deflection signal 7 is transmitted to the mechanical property calculating module, and the nanometer quantitative mechanical properties of the sample 9 are calculated semi-online. Specifically, the laser spot longitudinal deflection signal 7 is converted into a fifth acting force signal which refers to the curve of the interaction force of the distance between the probe tip and the sample. The quantitative values are determined by using, for example, an Oliver-Pharr model, a DMT model, a Snedden model, a Hertz model or other contact mechanical models and the upper part of a slope. The quantitative values comprise Van der Waals attraction and the capillary adhesion force that occurs when the tip leaves the sample.

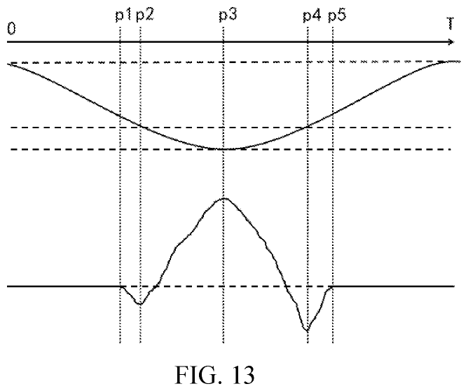

As shown in FIG. 12, when the real amplitude calculating module is composed of a phase sensitive detector, a low-pass filter and a sinusoidal signal generator, the laser spot longitudinal deflection signal 7 generated by the four-quadrant photoelectric detector 6 is transmitted to the phase sensitive detector, and the phase sensitive detector generates a fourth acting force signal and transmits the fourth acting force signal to the low-frequency filter. The low-frequency filter generates a real amplitude signal and transmits the real amplitude signal to the comparator 12. Other processes are the same as those in the above embodiments and will not be described here.

Wherein the other end (output end) of the integral operator or the low-frequency filter can also be connected with an instantaneous force point analysis unit; the instantaneous force point analysis unit is used for analyzing the real amplitude signal outputted by the integral operator (or the low-frequency filter) to obtain an instantaneous force point analysis signal; and the instantaneous force point analysis signal is used for quantitative analysis. The arrows drawn by the instantaneous force point analysis units in FIG. 11 and FIG. 12 indicate that the instantaneous force point analysis units output the instantaneous force point analysis signals.

The detected signal of the interaction between the probe tip 2 and the surface of sample 9 is shown in FIG. 13. The upper half part is the changing curve of the distance between the probe tip 2 and the sample 9 with time, and the lower half part is the changing curve of a longitudinal force with time. The longitudinal force comprises Van der Waals force, capillary adhesion and contact force between the probe tip 2 and the surface of sample 9.

The interaction between the probe tip 2 and the sample 9 comprises three intervals, and the time stamps of the three interaction intervals are marked by vertical straight lines p1 to p5. p1 to p2 indicate the interval of the Van der Waals force, p2 to p4 indicate the interval of the contact force, and p4 to p5 indicate the interval of the capillary adhesion. Synchronic signals are time stamp signals from p1 to p5.

Finally, it should be noted that the above embodiments are only used for describing the technical solution of the present invention rather than limiting the present invention. Although the present invention is described in detail by referring to the above embodiments, those ordinary skilled in the art should understand that: the technical solution recorded in each of the above embodiments can be still amended, or part or all of technical features therein can be replaced equivalently; and the amendments or replacements do not enable the essence of the corresponding technical solution to depart from the scope of the technical solution of various embodiments of the present invention.

1. A scanning method for a scanning probe microscope based on high-speed instantaneous force control, wherein the scanning probe microscope comprises a probe unit, characterized by comprising the following steps:
acquiring an acting force signal between a probe unit and a sample, wherein the acting force signal represents the feature that the acting force on the sample changes with time;
calculating a real amplitude signal according to the acting force signal, wherein the real amplitude signal represents the amplitude of the acting force signal;
acquiring a set amplitude signal;
acquiring a first sinusoidal signal, and obtaining a target acting force signal according to the real amplitude signal, the set amplitude signal and the first sinusoidal signal;
scanning the surface of the sample in a target sample scanning mode according to the target acting force signal, wherein the target sample scanning mode represents the operating mode of scanning the surface of the sample under the indication of the target acting force signal.

2. The scanning method for the scanning probe microscope based on high-speed instantaneous force control according to claim 1, characterized in that the specific steps of calculating the real amplitude signal according to the acting force signal comprise:
acquiring a second sinusoidal signal, and generating a background signal according to the second sinusoidal signal under the trigger of the acting force signal;
obtaining a first acting force signal according to the background signal and the acting force signal, wherein the first acting force signal represents a first real acting force signal after the background signal is subtracted;
obtaining an average baseline signal according to the first acting force signal, wherein the average baseline signal represents the average baseline of the first acting force signal;
obtaining a second acting force signal according to the average baseline signal and the first acting force signal, wherein the second acting force signal represents a second real acting force signal after the average baseline signal is subtracted from the first acting force signal;
obtaining a third acting force signal according to the second acting force signal, wherein the third acting force signal represents a third real acting force signal after the second acting force signal is positive;
obtaining the real amplitude signal according to the third acting force signal.

3. The scanning method for the scanning probe microscope based on high-speed instantaneous force control according to claim 1, characterized in that the specific steps of calculating the real amplitude signal according to the acting force signal comprise:
acquiring a third sinusoidal signal;
obtaining a fourth acting force signal according to the third sinusoidal signal and the acting force signal, wherein the fourth acting force signal represents a signal obtained by mixing and multiplying the acting force signal and the third sinusoidal signal;
obtaining the real amplitude signal according to the fourth acting force signal, wherein the real amplitude signal represents the amplitude signal of the acting force signal.

4. The scanning method for the scanning probe microscope based on high-speed instantaneous force control according to claim 2, characterized in that the specific steps of acquiring the first sinusoidal signal, and obtaining the target acting force signal according to the real amplitude signal, the set amplitude signal and the first sinusoidal signal comprise:
obtaining an error signal according to the real amplitude signal and the set amplitude signal, wherein the error signal represents the error information of the real amplitude signal and the set amplitude signal;
obtaining a control signal according to the error signal;
acquiring the first sinusoidal signal;
obtaining the target acting force signal according to the first sinusoidal signal and the control signal.

5. The scanning method for the scanning probe microscope based on high-speed instantaneous force control according to claim 4, characterized in that the specific steps of acquiring the acting force signal between the probe unit and the sample comprise:
acquiring the target acting force signal;
conducting scanning in the target sample scanning mode according to the target acting force signal;
detecting a scanning process during the scanning in the target sample scanning mode, to generate the acting force signal.

6. A method for measuring mechanical properties based on a scanning probe microscope, used for measuring the mechanical properties of the surface of the sample, characterized in that the method comprises the following steps:
scanning the surface of the sample according to the scanning method for the scanning probe microscope based on high-speed instantaneous force control of claim 1 to form scanning motion, and obtaining the acting force signal, wherein the acting force signal represents the feature that the acting force signal changes with time;
obtaining quantitative values according to the acting force signal, wherein the quantitative values represent the surface features of the sample.

7. The method for measuring mechanical properties based on the scanning probe microscope according to claim 6, characterized in that the specific steps of obtaining the quantitative values according to a sample scanning signal comprise:
obtaining a fifth acting force signal according to the sample scanning signal, wherein the fifth acting force signal represents the feature that the acting force on the sample changes with a distance between the sample and a force applying side;
determining several quantitative values according to a contact mechanical model and the fifth acting force signal.

8. The method for measuring mechanical properties based on the scanning probe microscope according to claim 7, characterized in that the quantitative values comprise: Van der Waals force or/and capillary adhesion between the sample and the force applying side.

9. A scanning device for a scanning probe microscope based on high-speed instantaneous force control, characterized by comprising:
a scanning module, a real amplitude calculating module, a set amplitude generating module and a target acting force signal generating module;
one end of the scanning module is connected with one end of the real amplitude calculating module, and the other end of the scanning module is connected with one end of the target acting force signal generating module; and the other end of the target acting force signal generating module is connected with the other end of the real amplitude calculating module and the set amplitude generating module;
the scanning module is used for scanning the surface of the sample to generate the acting force signal and transmitting the acting force signal to the real amplitude calculating module;
the real amplitude calculating module is used for obtaining the real amplitude signal according to the acting force signal and transmitting the real amplitude signal to the target acting force signal generating module;
the set amplitude generating module is used for generating the set amplitude signal and transmitting the set amplitude signal to the target acting force signal generating module;
the target acting force signal generating module is used for generating the target acting force signal by the real amplitude signal and the set amplitude signal and transmitting the target acting force signal to the scanning module, so as to control the scanning module to conduct scanning operation in the target sample scanning mode according to the target acting force signal.

10. The scanning device for the scanning probe microscope based on high-speed instantaneous force control according to claim 9, characterized in that the scanning module specifically comprises:
a beam transmitting unit, a signal detecting unit, a longitudinal piezoelectric driving unit, a probe holding unit, a probe cantilever beam unit and a probe unit;
wherein one end of the probe unit is installed in the probe holding unit, the probe cantilever beam unit is connected with the probe holding unit, the probe cantilever beam unit supports the probe unit, and the other end of the probe unit extends from the probe cantilever beam unit; one end of the longitudinal piezoelectric driving unit is connected with the probe holding unit, and the other end of the longitudinal piezoelectric driving unit is connected with the target acting force signal generating module; and the signal detecting unit is connected with one end of the real amplitude calculating module;
the probe unit is used for periodically acting on the surface of the sample with a certain acting force; and the probe unit is controlled by the longitudinal piezoelectric driving unit;
the longitudinal piezoelectric driving unit is used for driving the probe unit to operate in the target sample scanning mode by using a received target sample scanning signal;
the beam transmitting unit is used for transmitting a light beam to the probe cantilever beam unit;
the probe cantilever beam unit is used for supporting the probe unit together with the probe holding unit and reflecting the received light beam transmitted by the beam transmitting unit into the signal detecting unit;
the signal detecting unit is used for generating the sample scanning signal according to the detected reflected light beam on the probe cantilever beam unit and transmitting the sample scanning signal to a mechanical property calculating module and the real amplitude calculating module.

11. The scanning device for the scanning probe microscope based on high-speed instantaneous force control according to claim 10, characterized in that the real amplitude calculating module specifically comprises:
a background generating unit, a first comparison unit, a baseline average analysis unit, a second comparison unit, a signal positivity unit, a second integral operation unit and a sinusoidal signal generating unit;
one end of the background generating unit is connected with the signal detecting unit, and the other end of the background generating unit is connected with one end of the first comparison unit and one end of the sinusoidal signal generating unit; one end of the first comparison unit is also connected with the signal detecting unit, and the other end of the first comparison unit is connected with one end of the baseline average analysis unit and one end of the second comparison unit; the other end of the baseline average analysis unit is connected with one end of the second comparison unit; the other end of the second comparison unit is connected with one end of the signal positivity unit; the other end of the signal positivity unit is connected with one end of the second integral operation unit; and the other end of the second integral operation unit is connected with the target acting force signal generating module;
the sinusoidal signal generating unit is used for generating the first sinusoidal signal, the second sinusoidal signal or the third sinusoidal signal, transmitting the second sinusoidal signal or the third sinusoidal signal to the real amplitude calculating module, and transmitting the first sinusoidal signal to the target acting force signal generating module;
the background generating unit is used for triggering the background generating unit to generate a background signal according to the received second sinusoidal signal when the acting force signal is received, and transmitting the background signal to the first comparison unit;
the first comparison unit is used for obtaining the first acting force signal according to the received background signal and the acting force signal, and transmitting the first acting force signal to the baseline average analysis unit and the second comparison unit;
the baseline average analysis unit is used for generating an average baseline signal according to the received first acting force signal and transmitting the average baseline signal to the second comparison unit;
the second comparison unit is used for obtaining the second acting force signal according to the received average baseline signal and the first acting force signal, and transmitting the second acting force signal to the signal positivity unit;
the signal positivity unit is used for obtaining the third acting force signal according to the second acting force signal, and transmitting the third acting force signal to the second integral operation unit;
the second integral operation unit is used for obtaining the real amplitude signal according to the third acting force signal and transmitting the real amplitude signal to the target acting force signal generating module.

12. The scanning device for the scanning probe microscope based on high-speed instantaneous force control according to claim 10, characterized in that the real amplitude calculating module specifically comprises:
a phase sensitive detection unit and a low-pass filter unit;
one end of the phase sensitive detection unit is connected with the signal detecting unit, the other end of the phase sensitive detection unit is connected with one end of the low-pass filter unit, and the other end of the low-pass filter unit is connected with the target acting force signal generating module;
the phase sensitive detection unit is used for obtaining the fourth acting force signal according to the received acting force signal and the third sinusoidal signal, and transmitting the fourth acting force signal to the low-pass filtering unit;
the low-pass filter unit is used for obtaining the real amplitude signal according to the fourth acting force signal and transmitting the real amplitude signal to the target acting force signal generating module.

13. The scanning device for the scanning probe microscope based on high-speed instantaneous force control according to claim 11, characterized in that the target acting force signal generating module specifically comprises:
a third comparison unit, a control signal generating unit and a summing unit;
one end of the third comparison unit is connected with the other end of the real amplitude calculating module and the set amplitude calculating module; the other end of the third comparison unit is connected with one end of the control signal generating unit; the other end of the control signal generating unit is connected with one end of the summing unit; and the other end of the summing unit is connected with the other end of the longitudinal piezoelectric driving unit and the other end of the sinusoidal signal generating unit;
the third comparison unit is used for generating an error signal according to the real amplitude signal and the set amplitude signal, and transmitting the error signal to the control signal generating unit;
the control signal generating unit is used for generating a control signal according to the error signal and transmitting the control signal to the summing unit;
the summing unit is used for generating the target acting force signal according to the first sinusoidal signal and the control signal and transmitting the target acting force signal to the scanning module.

14. A scanning system for a scanning probe microscope based on high-speed instantaneous force control, characterized by comprising: the scanning device for the scanning probe microscope based on high-speed instantaneous force control in claim 9, which is used for scanning the sample under the control of the set amplitude signal and generating the acting force signal; and
a mechanical property calculating module, wherein the mechanical property calculating module is connected with the scanning module for receiving the acting force signal transmitted by the scanning module and calculating quantitative values according to the acting force signal, and the quantitative values represent the surface features of the sample.
